(19) United States
(12) Patent Application Publication
(10) Pub. No.: US 2016/0226539 A1
(43) Pub. Date: Aug. 4, 2016

(54) RECEIVER CONTROL BASED ON ERROR DETECTION IN MULTIPLE, SIMULTANEOUS RADIO ACCESS TECHNOLOGY ENVIRONMENTS

(71) Applicant: QUALCOMM Incorporated, San Diego, CA (US)

(72) Inventors: Bhaskara Viswanadham Batchu, Hyderabad (IN); Sharad Shahi, Boulder, CO (US); Chintan Shirish Shah, San Diego, CA (US)

(21) Appl. No.: 14/611,603

(22) Filed: Feb. 2, 2015

(51) Int. Cl. H04B 1/16; H04W 88/06

(52) U.S. Cl. CPC H04B 1/16; H04W 88/06

(57) ABSTRACT

Systems, methods, apparatuses, and media are provided for improved receiver control based on error detection results in multiple, simultaneous radio access technology environments. Communication may be performed using a first radio access technology on a first receiver. A first communication for a second radio access technology may be received on a second receiver. A determination may be made as to whether to receive a second communication for the second radio access technology on the first receiver based on an error detection result for the first communication.

### BACKGROUND

1. Field

Embodiments described herein generally relate to systems and methods for improved receiver control based on error detection results in multiple, simultaneous radio access technology environments.

2. Background

A user equipment (“UE”), such as a mobile phone device, may be enabled for one or more radio access technologies (“RATs”), such as Frequency Division Multiple Access (“FDMA”), Time Division Multiple Access (“TDMA”), Code Division Multiple Access (“CDMA”), Universal Mobile Telecommunications Systems (“UMTS”) (particularly, Long Term Evolution (“LTE”)), Global System for Mobile Communications (“GSM”), Wi-Fi, PCS, or other protocols that may be used in a wireless communications network or a data communications network. One or more RATs may be enabled by one, or a plurality of subscriber identity modules (“SIMs”). For example, a UE may be a multi-SIM UE, where each of a plurality of SIMs received or otherwise coupled to the multi-SIM UE may support one or more RATs.

### SUMMARY

Various embodiments relate to systems and methods for improved receiver control based on error detection results in multiple, simultaneous radio access technology environments.

According to some embodiments, a method includes communicating using a first radio access technology on a first receiver. The method further includes receiving a first communication for a second radio access technology on a second receiver. The method further includes determining whether to receive a second communication for the second radio access technology on the first receiver based on an error detection result for the first communication.

In some embodiments, determining whether to receive the second communication for the second radio access technology on the first receiver results in a determination to use the first receiver for reception of the second communication for the second radio access technology if the error detection result for the first communication indicates an error for the first communication.

In some embodiments, determining whether to receive the second communication for the second radio access technology on the first receiver results in a determination to not use the first receiver for reception of the second communication for the second radio access technology if the error detection result for the first communication does not indicate an error for the first communication.

In some embodiments, the method further includes receiving the second communication for the second radio access technology on the first receiver if the error detection result for the first communication indicates an error for the first communication.

In some embodiments, the method further includes receiving the second communication for the second radio access technology on the second receiver if the error detection result for the first communication does not indicate an error for the first communication.

In some embodiments, the first communication comprises one or more bits. In such embodiments, the error detection result for the first communication indicates whether or not the one or more bits were received in error.

In some embodiments, the first communication comprises one or more bits. In such embodiments, the error detection result for the first communication indicates whether or not all information bits included in the first communication could be successfully recovered.

In some embodiments, the first communication comprises one or more bits. In such embodiments, the error detection result for the first communication indicates whether or not the one or more bits were detected as being in error after a decoding operation was performed for the first communication.

In some embodiments, the error detection result for the first communication indicates whether or not one or more bits of the first communication were detected as being in error after an error correction operation was performed for the first communication.

In some embodiments, the error detection result for the first communication indicates whether or not a block error was detected in the first communication.

In some embodiments, the error detection result for the first communication is a result of applying a cyclic redundancy check algorithm to a block of data received as part of the first communication.

In some embodiments, determining whether to receive the second communication for the second radio access technology on the first receiver is not performed based on a signal strength indicator.

In some embodiments, determining whether to receive the second communication for the second radio access technology on the first receiver is not performed based on a signal strength indicator for the second radio access technology during reception of the first communication for the second radio access technology on the second receiver.

In some embodiments, the method further includes stopping communication using the first radio access technology on the first receiver. In such embodiments, the method further includes receiving the second communication for the second radio access technology on the first receiver, after stopping the communication using the first radio access technology on the first receiver. In such embodiments, the method further includes resuming the communication or starting a new communication using the first radio access technology on the first receiver, after receiving the second communication for the second radio access technology on the first receiver.

In some embodiments, the method further includes stopping a communication using the first radio access technology on the second receiver, before receiving the first communication for the second radio access technology on the second receiver. In such embodiments, the method further includes receiving the first communication for the second radio access technology on the second receiver, after stopping the communication using the first radio access technology on the second receiver. In such embodiments, the method further includes resuming the communication or starting a new communication using the first radio access technology on the second receiver, after receiving the first communication for the second radio access technology on the second receiver. In such embodiments, communicating using a first radio access technology on a first receiver comprises communicating using the first radio access technology on the second receiver, before receiving the first communication for the second radio access technology on the second receiver.

In some embodiments, the method further includes determining to receive the second communication for the second radio access technology on the first receiver based on the error detection result for the first communication indicating that an error was detected for the first communication. In such embodiments, the method further includes stopping the communication using the first radio access technology on the first receiver, before receiving the second communication for the second radio access technology on the first receiver. In such embodiments, the method further includes receiving the second communication for the second radio access technology on the first receiver, after stopping the communication using the first radio access technology on the first receiver. In such embodiments, the method further includes resuming the communication or starting a new communication using the first radio access technology on the first receiver, after receiving the second communication for the second radio access technology on the first receiver.

In some embodiments, the method further includes stopping the communication using the first radio access technology on the second receiver, before receiving the second communication for the second radio access technology on the second receiver. In such embodiments, the method further includes receiving the second communication for the second radio access technology on the second receiver, after stopping the communication using the first radio access technology on the second receiver. In such embodiments, the method further includes resuming the communication or starting a new communication using the first radio access technology on the second receiver, after receiving the second communication for the second radio access technology on the second receiver.

In some embodiments, the method further includes determining to receive the second communication for the second radio access technology on the second receiver based on the error detection result for the first communication indicating that no error was detected for the first communication. In such embodiments, the method further includes stopping communication using the first radio access technology on the second receiver, before receiving the second communication for the second radio access technology on the second receiver. In such embodiments, the method further includes receiving the second communication for the second radio access technology on the second receiver, after stopping communication using the first radio access technology on the second receiver. In such embodiments, the method further includes resuming the communication or starting a new communication using the first radio access technology on the second receiver, after receiving the second communication for the second radio access technology on the second receiver.

In some embodiments, the first communication for the second radio access technology is received on the second receiver based on a tune-away operation on the second receiver from the first radio access technology to the second radio access technology.

In some embodiments, determining whether to receive a second communication for the second radio access technology on the first receiver comprises determining whether to perform a tune-away operation on the first receiver in order to receive the second communication.

In some embodiments, the first communication for the second radio access technology is a paging message for the second radio access technology. In such embodiments, the second communication for the second radio access technology is a paging message for the second radio access technology.

In some embodiments, the second communication for the second radio access technology is a next paging message for the second radio access technology expected to be received one paging interval in time after the first communication.

In some embodiments, communicating using the first radio access technology comprises performing active mode communications with a data network radio access technology. In such embodiments, the first communication for the second radio access technology comprises an idle mode communication with a voice network radio access technology. In such embodiments, the second communication for the second radio access technology comprises an idle mode communication with the voice network radio access technology.

In some embodiments, the first receiver is a receiver with a greater sensitivity than the second receiver.

In some embodiments, the second receiver provides spatial diversity reception for signals received at the first receiver.

In some embodiments, the first radio access technology is different from the second radio access technology.

According to some embodiments, a user equipment (UE) apparatus includes a first receiver configured to communicate using a first radio access technology, and a second receiver configured to receive a first communication for a second radio access technology. The UE apparatus further includes a processor configured to determine whether to receive a second communication for the second radio access technology on the first receiver based on an error detection result for the first communication.

According to some embodiments, a user equipment (UE) apparatus includes means for communicating using a first radio access technology on a first receiver. The UE apparatus further includes means for receiving a first communication for a second radio access technology on a second receiver. The UE apparatus further includes means for determining whether to receive a second communication for the second radio access technology on the first receiver based on an error detection result for the first communication.

According to some embodiments, a non-transitory computer-readable medium includes instructions configured to cause one or more computing devices to communicate using a first radio access technology on a first receiver. The medium includes instructions configured to cause one or more computing devices to receive a first communication for a second radio access technology on a second receiver. The medium includes instructions configured to cause one or more computing devices to determine whether to receive a second communication for the second radio access technology on the first receiver based on an error detection result for the first communication.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a schematic diagram illustrating an example of a system according to various embodiments.

FIG. 2 is a functional block diagram illustrating an example of a user equipment according to various embodiments.

FIG. 3 is a schematic diagram illustrating an example of a user equipment according to various embodiments.

FIG. 4 is a schematic diagram illustrating a communication sequence according to various embodiments.

FIG. 5 is a schematic diagram illustrating a communication sequence according to various embodiments.

FIG. 6 is a flowchart of a process according to various embodiments.

FIG. 7 is a flowchart of a process according to various embodiments.

FIG. 8 is a flowchart of a process according to various embodiments.

FIG. 9 is a flowchart of a process according to various embodiments.

FIG. 10 is a component block diagram of a user equipment suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claim.

Various modern communication devices are described herein. Such a modern communication device may be referred to herein as a user equipment (“UE”). However, such a modern communication device may also be referred to as a mobile station (“MS”), a wireless device, a communications device, a wireless communications device, a mobile device, a mobile phone, a mobile telephone, a cellular device, a cellular telephone, and in other ways. Examples of UE include, but are not limited to, mobile phones, laptop computers, smart phones, and other mobile communication devices of the like that are configured to connect to one or more RATs.

Some UE may contain one or more subscriber identity modules (“SIMs”) that provide users of the UEs with access to one or multiple separate mobile networks, supported by radio access technologies (“RATs”). Examples of RATs may include, but are not limited to, Global Standard for Mobile (“GSM”), Code Division Multiple Access (“CDMA”), CDMA2000, Time Division-Code Division Multiple Access (“TD-CDMA”), Time Division-Synchronous Code Division Multiple Access (“TD-SCDMA”), Wideband-Code Division Multiple Access (“W-CDMA”), Time Division Multiple Access (“TDMA”), Frequency Division Multiple Access (“FDMA”), Long-Term Evolution (“LTE”), wireless fidelity (“Wi-Fi”), various 3G standards, various 4G standards, and the like.

Embodiments described herein relate to both single-SIM and multi-SIM UEs. A UE that includes a plurality of SIMs and connects to two or more separate RATs using a same set of RF resources (e.g., radio-frequency (“RF”) transceivers) is a multi-SIM-multi-standby (“MSMS”) communication device. In one example, the MSMS communication device may be a dual-SIM-dual-standby (“DSDS”) communication device, which may include two SIM cards/subscriptions that may both be active on standby, but one is deactivated when the other one is in use. In another example, the MSMS communication device may be a triple-SIM-triple-standby (“TSTS”) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

Further, a UE that includes a plurality of SIMs and connects to two or more separate mobile networks using two or more separate sets of RF resources is termed a multi-SIM-multi-active (“MSMA”) communication device. An example MSMA communication device is a dual-SIM-dual-active (“DSDA”) communication device, which includes two SIM cards/subscriptions, each associated with a separate RAT, where both SIMs may remain active at any given time. In another example, the MSMA device may be a triple-SIM-triple-active (“TSTA”) communication device, which includes three SIM cards/subscriptions, each associated with a separate RAT, where all three SIMs may remain active at any given time. In other examples, the MSMA communication device may be other suitable multi-SIM communication devices, with, for example, four or more SIMs, such that all SIMs are active at any given time.

In addition, a plurality of modes may be enabled by one SIM such that each mode may correspond to a separate RAT. Such a SIM is a multi-mode SIM. A UE may include one or more multi-mode SIMs. The UE may be a MSMS communication device (such as, but not limited to, a DSDS or a TSTS communication device), a MSMA communication device (e.g., a DSDA, TSTA communication device, or the like), or a multi-mode device.

As used herein, UE refers to one of a cellular telephone, smart phone, personal or mobile multi-media player, personal data assistant, laptop computer, personal computers, tablet computer, smart book, palm-top computer, wireless electronic mail receiver, multimedia Internet-enabled cellular telephone, wireless gaming controller, and similar personal electronic device that include one or more SIMs, a programmable processor, memory, and circuitry for connecting to one or more mobile communication networks (simultaneously or sequentially). Various embodiments may be useful in mobile communication devices, such as smart phones, and such devices are referred to in the descriptions of various embodiments. However, the embodiments may be useful in any electronic device, such as a DSDS, a TSTS, a DSDA, a TSTA communication device (or other suitable multi-SIM, multi-mode devices), that may individually maintain one or more subscriptions that utilize one or a plurality of separate set of RF resources.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the UE to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and subscriptions supported by that network, correlate to one another.

Embodiments described herein are directed to systems and methods for improved receiver control based on error detection results in multiple, simultaneous radio access technology environments. In environments where a UE supports multiple, simultaneous RATs, the UE may be required to employ various techniques for managing shared RF resources across those multiple RATs. For example, the UE may be required to allow both a first RAT and a second RAT to have periodic access to a primary RF chain, even though the radio access network (“RAN”) components (e.g., base stations, eNodeBs, etc.) for each of the first RAT and the second RAT do not coordinate their transmissions. As such, the UE may be required to selectively provide RF resources for communication on each of the first RAT and the second RAT despite conflicting demands for those RF resources.

In some configurations, the UE may contain a first receiver and a second receiver. The UE may be configured to use both of the first receiver and the second receiver to communicate using the first RAT. However, the UE may provide the second receiver for communication using the second RAT as needed. This approach may allow reception of communications for the second RAT while introducing slight errors in reception of communications for the first RAT (due to loss of the second receiver). This approach may be used when an active mode data communication requiring near constant receiver access is taking place on the first RAT, while less intensive idle mode communication is taking place on the second RAT. As an example, the UE may perform connected state communication with an LTE RAT on both the first receiver and second receiver, and the UE may periodically provide the second receiver for reception of a paging message on a CDMA2000 RAT. However, even with this approach, errors may occur for the second RAT communication while using the second receiver. This may be the case due to a poorer sensitivity for the second receiver as compared to the first receiver, or for other reasons. In some situations, a signal strength indicator (e.g., Ec/Io) for the second RAT may be used to determine if the second receiver is insufficient to receive the communication for the second RAT. If the signal strength indicator does not meet some predefined threshold, then the UE may provide the first receiver for the second RAT communication. This approach may improve reception of communications for the second RAT, but this approach may introduce significant errors in reception of communications for the first RAT (due to loss of the first receiver). As such, the determination to provide the first receiver for reception of communications on the second RAT should only be made as absolutely necessary.

However, a signal strength indicator may not be highly predictive of whether provision of the first receiver for reception of communications on the second RAT is absolutely necessary. Signal strength indicators may be deemed a logical metric for driving the determination for receiver allocation to the first RAT and the second RAT, at least because a weak signal in the downlink is expected to cause poor reception of the second RAT communication and a strong signal in the downlink is expected to cause good reception of the second RAT communication. Nonetheless, this general relationship between signal strength indicators and signal reception may suffer for two reasons. First, other factors may improve or degrade the reception of the second RAT communication apart from signal strength indicators. For example, the magnitude of desense occurring at the second receiver may vary with time and effectively change the sensitivity of the second receiver apart from the observed or measured signal strength indicators. As such, the signal strength indicators may not predict with great accuracy the quality with which the second RAT communication will be received at the second receiver. Second, the signal strength indicators may be overly biased in favor of providing the first receiver to the second RAT (i.e., overly pessimistic indicators of signal reception on the second receiver). For example, a signal strength indicator of Echo below some predefined threshold may cause the first receiver to be provided for the second RAT communication, whereas the second RAT communication could have been successfully received and decoded using only the second receiver. This may be the case based on mere chance of correct reception, gains from multipath, encoding techniques (e.g., forward error correction), or other reasons. As such, the signal strength indicators may cause provision of the first receiver to the second RAT even in cases where it would not be necessary. For at least these two reasons, signal strength indicators may not be ideal for use as the basis for determination of receiver or other RF resource allocation.

Accordingly, various embodiments described herein are directed to systems and methods for more effectively determining the provision of shared RF resources to multiple RATs. In some embodiments, a UE may use the second receiver for reception of a first communication for the second RAT. The UE may determine an error detection result for that first communication so as to determine if the first communication was received in error. If the first communication was not received in error, then the UE may again provide the second receiver for the next communication for the second RAT, at least because the second receiver was effective to receive the first communication. However, if the first communication was received in error, then the UE may provide the first receiver for the next communication for the second RAT. As an example, the UE may provide the first receiver and the second receiver for communication with an LTE RAT. The UE may provide the second receiver for reception of a first paging message for a CDMA2000 RAT. If a cyclic redundancy check (“CRC”) result for the first paging message indicates that the paging message was received and decoded without any block errors, then the UE may again provide the second receiver for reception of the next paging message for the CDMA2000 RAT. However, if the CRC result for the first paging message indicates that the paging message was not successfully decoded (i.e., the CRC result indicates block errors), then the UE may provide the first receiver for reception of the next paging message for the CDMA2000 RAT.

Determinations based on error detection results may be more effective than the aforementioned techniques based on signal strength indictors at least based on the greater accuracy of the error detection results. In particular, the error detection result may accurately report whether the second RAT communication was actually received in error. While the signal strength indicators provide a sort of prediction of success of the second RAT communication, the error detection result provides an actual indication of whether the information bits contained in the second RAT communication were successfully recovered. As such, while the signal strength indicators may not appropriately predict numerous factors including desense variations, inherent randomness in downlink channel noise effects, and enhanced recovery techniques in the receiver circuitry, the error detection result can incorporate these factors as the error detection result is determined after all of these factors have been applied. Therefore, the use of an error detection result may improve over techniques using signal strength indicators because the inherent degradation of signal reception for the first RAT caused by providing the first receiver to the second RAT will only be caused when recovery of information bits for communications on the second RAT actually fail with use of the second receiver.

Determinations based on error detection results may be more effective than the aforementioned techniques based on signal strength indictors at least based on the greater predictability in signal reception when using error detection results. In particular, the use of error detection results to determine the provision of the first receiver may effectively limit the number of consecutive communications lost for the second RAT to a single communication. Namely, with use of the error detection result, any communication for the second RAT that is not successfully decoded may cause the next communication for the second RAT to use the first receiver. Use of the first receiver may be expected to cause successful reception of the next communication for the second RAT. As such, while the use of error detection results in this way may allow a first communication for the second RAT to be lost, it is expected that the next communication for the second RAT will not be lost. This thereby may result in an expectation that a maximum of one consecutive communication will be lost for the second RAT. On the other hand, techniques using signal strength indicators may lack this predictability. For example, consider a scenario in which a UE receives a first communication for the second RAT on the second receiver while simultaneously determining a signal strength indicator. In this case, the UE may fail to successfully recover the information bits of the first communication (e.g., due to desense, randomness in downlink noise, etc.) even though the signal strength indicator is at or above a predetermined acceptable threshold. Then, for the next communication for the second RAT, the UE may provide the second receiver. But, due to a drop in signal strength for the second RAT, the next communication may also be lost. Therefore, two consecutive communications for the second RAT may be lost. This may be a common scenario, but more uncommon scenarios (e.g., signal strength indicator consistently just above acceptable threshold, channel signal quality rapidly improving and degrading) may cause even greater consecutive losses of communications for the second RAT. Therefore, techniques using error detection results may be more effective than techniques using signal strength indicators because the latter may not be able to provide an expected upper bound on consecutive communication loss.

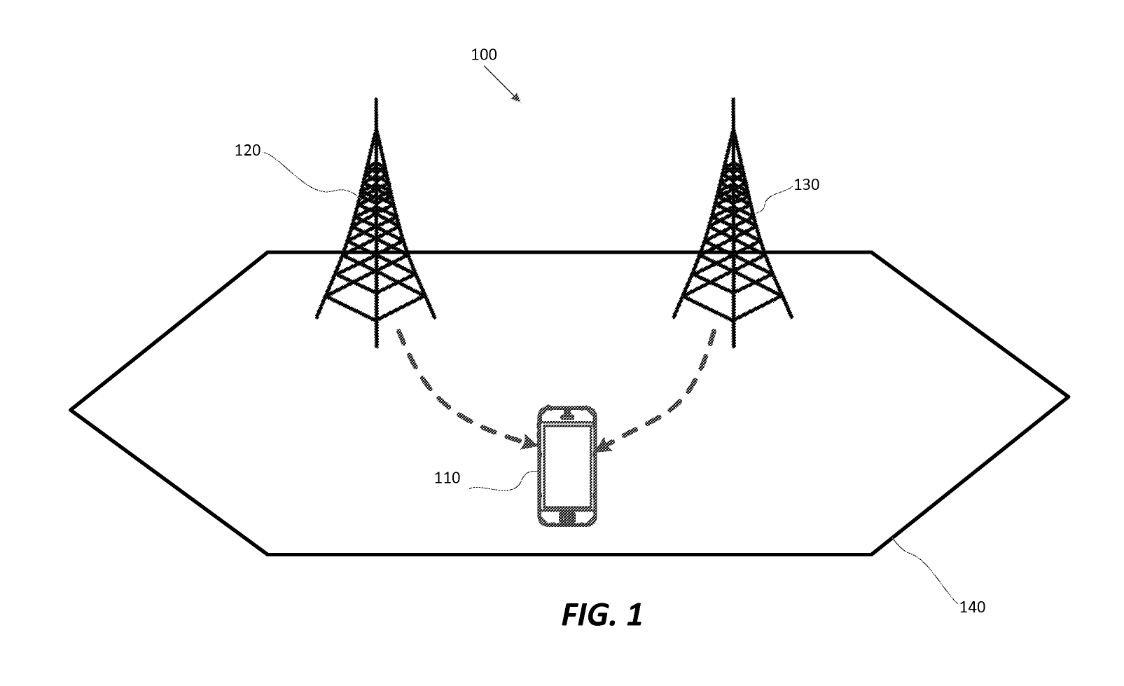

With reference to FIG. 1, a schematic diagram of a system 100 is shown in accordance with various embodiments. The system 100 may include a UE 110, a first base station 120, and a second base station 130. In some embodiments, each of the first base station 120 and the second base station 130 may represent a separate RAT, such as GSM, CDMA, CDMA2000, TD-CDMA, TD-SCDMA, W-CDMA, TDMA, FDMA, LTE, Wi-Fi, various 3G standards, various 4G standards, and/or the like. In other words, the first base station 120 may represent a first RAT, and the second base station may represent a second RAT, where the first RAT and the second RAT are different RATs. By way of illustrating with a non-limiting example, the first base station 120 may be transmitting W-CDMA while the second base station 130 may be transmitting GSM. In some embodiments, each RAT may be transmitted by the associated base station at different physical locations (i.e., the first base station 120 and the second base station 130 may be at different locations). In other embodiments, each RAT may be transmitted by the associated base station at the same physical location (i.e., the first base station 120 and the second base station 130 may be physically joined, or the base stations are the same base station).

The first base station 120 and the second base station 130 may each include at least one antenna group or transmission station located in the same or different areas, where the at least one antenna group or transmission station may be associated with signal transmission and reception. The first base station 120 and the second base station 130 may each include one or more processors, modulators, multiplexers, demodulators, demultiplexers, antennas, and the like for performing the functions described herein. In some embodiments, the first base station 120 and the second base station 130 may be utilized for communication with the UE 110 and may be an access point, Node B, evolved Node B (eNode B or eNB), base transceiver station (BTS), or the like.

A cell 140 may be an area associated with the first base station 120 and the second base station 130, such that the UE 110, when located within the cell 140, may connect to or otherwise access both the first and second RATs, as supported by the first base station 120 and the second base station 130 (e.g., receive signals from and transmit signals to the first base station 120 and the second base station 130), respectively. The cell 140 may be a defined area, or may refer to an undefined area in which the UE 110 may access the RATs supported by the base stations 120, 130.

In various embodiments, the UE 110 may be configured to access the RATs from the first base station 120 and/or the second base station 130 (e.g., receive/transmit signals of the first and/or the second RAT from/to the first base station 120 and/or the second base station 130). The UE 110 may be configured to access the RATs by virtue of the multi-SIM and/or the multi-mode SIM configuration of the UE 110 as described, such that when a SIM corresponding to a RAT is received, the UE 110 may be allowed to access that RAT, as provided by the associated base station.

In general, an acquisition process of a RAT refers to the process in which the UE 110 searches and acquires various communication protocols of the RAT in order to acquire and establish communication or traffic with the target base node that is broadcasting the RAT. Some communication protocols include synchronization channels, such as, but not limited to, primary synchronization channel (“P-SCH”), secondary synchronization channel (“S-SCH”), common pilot channel (“CPICH”), and the like. The target base nodes are nodes that transmit, broadcast, or otherwise support the particular RAT being acquired. In some embodiments, the first base station 120 may be a target base node for the first RAT, given that the first RAT may be transmitted by the first base station 120 as described. Thus, when the UE 110 initiates an acquisition process of the first RAT (as supported by the first base station 120), a communication channel is set for future communication and traffic between the UE 110 and the first base station 120. Similarly, the second base station 130 may be a target base node for the second RAT, which is transmitted by the second base station 130 as described. Thus, when the UE 110 initiates an acquisition process of the second RAT, a communication channel is set for future communication and traffic between the UE 110 and the second base station 130. The acquisition process may be initiated when the UE 110 seeks to initially access the RAT, or, after attaching to an initial RAT, to identify candidate target RAT (that is not the initial RAT) for a handover.

It should be appreciated by one of ordinary skill in the art that FIG. 1 and its corresponding disclosure are for illustrative purposes, and that the system 100 may include three or more base stations. In some embodiments, three or more base stations may be present, where each of the three or more base stations may represent (i.e., transmits signals for) one or more separate RATs in the manner such as, but not limited to, described herein.

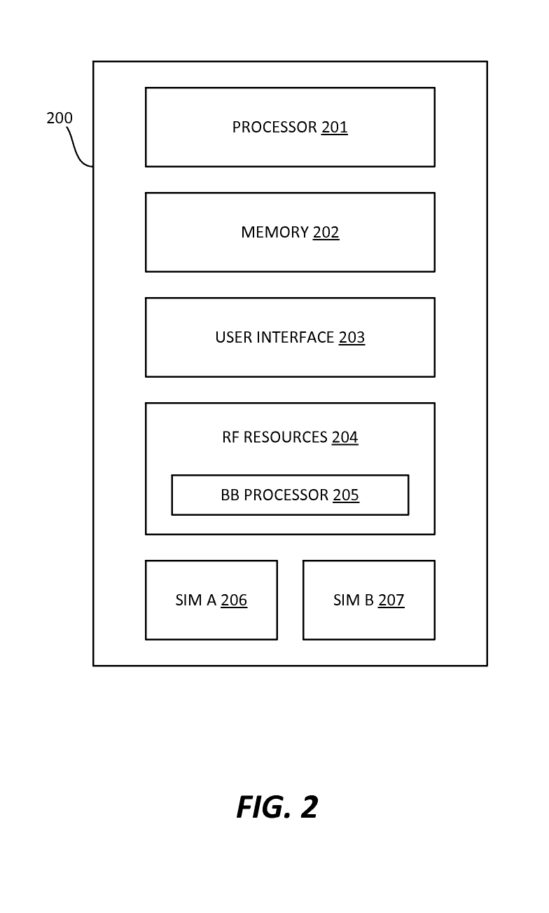

FIG. 2 is a functional block diagram of a UE 200 suitable for implementing various embodiments. According to various embodiments, the UE 200 may be the same or similar to the UE 110 as described with reference to FIG. 1. With reference to FIGS. 1-2, the UE 200 may include at least one processor 201, memory 202 coupled to the processor 201, a user interface 203, RF resources 204, and one or more SIMs (as denoted SIM A 206 and SIM B 207).

The processor 201 may include any suitable data processing device, such as a general-purpose processor (e.g., a microprocessor), but in the alternative, the processor 201 may be any suitable electronic processor, controller, microcontroller, or state machine. The processor 201 may also be implemented as a combination of computing devices (e.g., a combination of a DSP and a microprocessor, a plurality of microprocessors, at least one microprocessor in conjunction with a DSP core, or any other such configuration). The memory 202 may be operatively coupled to the processor 201 and may include any suitable internal or external device for storing software and data for controlling and use by the processor 201 to perform operations and functions described herein, including, but not limited to, random access memory RAM, read only memory ROM, floppy disks, hard disks, dongles or other USB connected memory devices, or the like. The memory 202 may store an operating system (“OS”), as well as user application software and executable instructions. The memory 202 may also store application data, such as an array data structure.

The user interface 203 may include a display and a user input device. In some embodiments, the display may include any suitable device that provides a human-perceptible visible signal, audible signal, tactile signal, or any combination thereof, including, but not limited to a touchscreen, LCD, LED, CRT, plasma, or other suitable display screen, audio speaker or other audio generating device, combinations thereof, and the like. In various embodiments, the user input device may include any suitable device that receives input from the use, the user input device including, but not limited to one or more manual operator (such as, but not limited to a switch, button, touchscreen, knob, slider or the like), microphone, camera, image sensor, and the like.

The processor 201 and the memory 202 may be coupled to the RF resources 204. In some embodiments, the RF resources 204 may be one set of RF resources such that only one RAT may be supported by the set of RF resources at any given time. In other embodiments, the RF resources may be a plurality of sets of RF resources, such that each set may support one RAT at a given time, thus enabling the UE 200 to support multiple RATs simultaneously, (e.g., in a MSMA case). The RF resources 204 may include at least one baseband-RF resource chain (with which each SIM in the UE 200, e.g., the SIM A 206 and the SIM B 207, may be associated). The baseband-RF resource chain may include a baseband modem processor 205, which may perform baseband/modem functions for communications on at least one SIM, and may include one or more amplifiers and radios. In some embodiments, baseband-RF resource chains may share the baseband modem processor 205 (i.e., a single device that performs baseband/modem functions for all SIMs on the UE 200). In other embodiments, each baseband-RF resource chain may include physically or logically separate baseband processors 205.

The RF resources 204 may include transceivers that perform transmit/receive functions for the associated SIM of the UE 200. The RF resources 204 may include separate transmit and receive circuitry, such as a separate transmitter and receiver, or may include a transceiver that combines transmitter and receiver functions. The RF resources 204 may each be coupled to a wireless antenna.

In some embodiments, the processor 201, the memory 202, and the RF resources 204 may be included in the UE 200 as a system-on-chip. In some embodiments, the one or more SIMs (e.g., SIM A 206 and SIM B 207) and their corresponding interfaces may be external to the system-on-chip. Further, various input and output devices may be coupled to components on the system-on-chip, such as interfaces or controllers.

The UE 110 is configured to receive one or more SIMs (e.g., SIM A 206 and SIM B 207), an example of which is described herein. A SIM in various embodiments may be a Universal Integrated Circuit Card (UICC) that is configured with SIM and/or USIM applications, enabling access to various RAT networks as described. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the UE 200, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

In some embodiments, the UE 200 may include a first SIM interface (not shown) that may receive a first SIM (e.g., SIM A 206), which may be associated with one or more RATs. In addition, the UE 200 may also include a second SIM interface (not shown) that may receive a second SIM (e.g., SIM B 207), which may be associated with one or more RATs that may be different (or the same in some cases) than the one or more RATs associated with SIM A 206. Each SIM may enable a plurality of RATs by being configured as a multi-mode SIM, as described herein. In some embodiments, a first RAT enabled may be a same or different RAT as a second RAT (e.g., a DSDS device may enable two RATs), for example where both of them may be GSM, or one of them may be GSM and the other may be W-CDMA. In addition, two RATs (which may be the same or different) may each be associated with a separate subscription, or both of them may be associated with a same subscription. For example, a DSDS device may enable LTE and GSM, where both of the RATs enabled may be associated with a same subscription, or, in other cases, LTE may be associated with a first subscription and GSM may be associated with a second subscription different from the first subscription.

In embodiments in which the UE 200 comprises a smart phone, or the like, the UE 200 may have existing hardware and software for telephone and other typical wireless telephone operations, as well as additional hardware and software for providing functions as described herein. Such existing hardware and software includes, for example, one or more input devices (such as, but not limited to keyboards, buttons, touchscreens, cameras, microphones, environmental parameter or condition sensors), display devices (such as, but not limited to electronic display screens, lamps or other light emitting devices, speakers or other audio output devices), telephone and other network communication electronics and software, processing electronics, electronic storage devices and one or more antennae and receiving electronics for receiving various RATs. In such embodiments, some of that existing electronics hardware and software may also be used in the systems and processes for functions as described herein.

Accordingly, such embodiments can be implemented with minimal additional hardware costs. However, other embodiments relate to systems and process that are implemented with dedicated device hardware (UE 200) specifically configured for performing operations described herein. Hardware and/or software for the functions may be incorporated in the UE 200 during manufacturing, for example, as part of the original equipment manufacturer's (“OEM's”) configuration of the UE 200. In further embodiments, such hardware and/or software may be added to the UE 200, after manufacturing of the UE 200, such as by, but not limited to, installing one or more software applications onto the UE 200.

In some embodiments, the UE 200 may include, among other things, additional SIM(s), SIM interface(s), additional RF resource(s) (i.e., sets of RF resources) associated with the additional SIM(s), and additional antennae for connecting to additional RATs supported by the additional SIMs.

Embodiments may be implemented in a UE that performs tune-away or other similar procedures to support communication with multiple RATs. In particular, embodiments may be implemented in a UE capable of concurrently communicating with more than one RAT on a single RF chain, (i.e., a single receiver/transmitter module). For example, a UE may be configured to communicate with both the AT&T W-CDMA network and the Verizon CDMA2000 network.

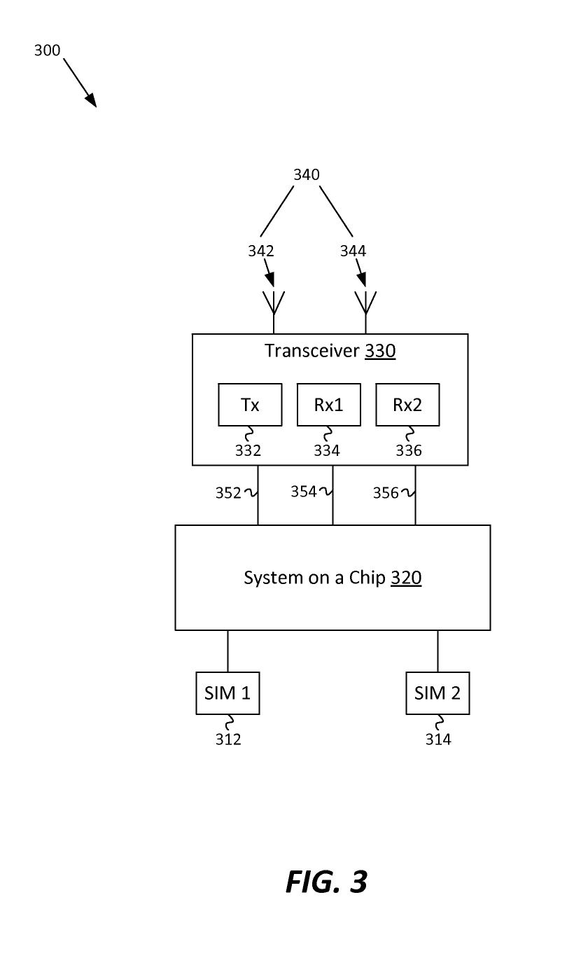

FIG. 3 is a schematic diagram illustrating an example of a UE 300 according to various embodiments. With reference to FIGS. 1-3, the UE 300 may correspond to the UE 110, 200. According to some embodiments, the UE 300 may include: SIM 1 312, SIM 2 314, system on a chip 320, transceiver 330, transmitter 332, first receiver 334, second receiver 336, antennas 340, first antenna 342, second antenna 344, connection 352, connection 354, and connection 356.

In some embodiments, the SIM 1 322 and the SIM 2 314 may be subscriber identity modules that provide subscriptions for multiple RATs. The SIM 1 312 and the SIM 2 314 may be provided similar to the SIM A 206 and the SIM B 207.

In some embodiments, the system on a chip 320 may include various components used for the operation of the UE 300, such as a processor, memory, and some RF resources. The system on a chip 320 may be provided as a combination of the processor 201, the memory 202, and portions of the RF resources 204. With respect to RF resources, the system on a chip 320 may be configured to contain components related to a modem functionality but not components related to transceiver functionality. For example, the system on a chip 320 may contain modulation and demodulation components. The system on a chip 320 may be configured to decode packets received by the UE 300, such as packets received by the first receiver 334 and/or the second receiver 336. The system on a chip 320 may be coupled to the transceiver 330 by the connections 352, 354, 356.

In some embodiments, the transceiver 330 may include the transmitter 332, the first receiver 334, and the second receiver 336. In order to support communication using multiple RATs, the transceiver 330 may support active use of the transmitter 332, the first receiver 334, and the second receiver 336 for an active connection on a first RAT, while occasionally switching the use of the second receiver 336 for an idle connection on a second RAT.

According to some embodiments, the first receiver 334 and the second receiver 336 may have respective sensitivities, which may be different. Generally, the sensitivity of a receiver may be defined as the minimum signal power required at the input of the receiver in order to produce a signal with a particular signal-to-noise ratio at the output of the receiver. In some embodiments, the first receiver 334 may have a greater sensitivity than the second receiver 336 may have. The first receiver 334 may be said to have a greater sensitivity if the first receiver 334 has a lower minimum signal power requirement than the second receiver 336, based on a same particular signal-to-noise-ratio value for the outputs of the receivers. In this way, a receiver may be said to have a greater sensitivity if it can receive a weaker input signal while still producing a predefined signal-to-noise ratio for an output signal, as compared to some other receiver. In some situations, a “greater” sensitivity may also be referred to as a “better” sensitivity or a “higher” sensitivity.

According to some embodiments, the first receiver 334 may be a primary receiver and the second receiver 336 may be a secondary receiver. In such embodiments, the first receiver 334 may be part of a primary RF chain for the transmission and reception of signals (e.g., along with the transmitter 332). In some embodiments, the second receiver 336 may function as a diversity receiver for the first receiver 334. In such embodiments, the second receiver 336 may provide a spatially diverse signal with respect to the signal received by the first receiver 334. As such, the second receiver 336 may provide spatial diversity to the first receiver 334. In some embodiments, the first receiver 334 and the second receiver 336 may be otherwise provided. For example, the first receiver 334 may be a diversity receiver and the second receiver 336 may be a primary receiver.

According to some embodiments, the UE 300 may support multiple-input and multiple-output (“MIMO”) communications using the transceiver 330. In such embodiments, the antennas 340 including the first antenna 342 and the second antenna 344 may be a MIMO pair of antennas. Furthermore, the first receiver 334 and the second receiver 336 may be a MIMO pair of receivers. For example, the UE 300 may be configured to receive two MIMO layers in a downlink transmission (e.g., from an evolved node B (“eNodeB”), base stations 120, 230). In order to receive the two MIMO layers, the UE 300 may be configured to receive communications on the first receiver 334 using the first antenna 342, and the UE 300 may be configured to receive communications on the second receiver 336 using the second antenna 344. The transceiver 330 may provide the signals received on the first receiver 334 and the second receiver 336 (e.g., using connections 354, 356) as input to the system on a chip 320. The system on a chip 320 may then recover the information bits in the two MIMO layers by decoding the signals received on the first receiver 334 and the second receiver 336. The UE 300 may support other MIMO and non-MIMO configurations in various embodiments.

According to some embodiments, a “rank” may indicate the configuration of the downlink transmission channel to the UE 300. In particular, in embodiments where the UE 300 is configured to support multiple downlink transmission/reception configurations, the rank may indicate which configuration is being used by the base station (e.g., base station 120) and/or the UE 300. When the base station is transmitting a signal with two MIMO layers in the downlink to the UE 300, the base station may be said to be using rank 2. When the base station is transmitting a signal with only one symbol or layer, and thus not using MIMO due to the lack of “multiple-output,” the base station may be said to be using rank 1. When the UE 300 is receiving the downlink signal using both the first receiver 334 and the second receiver 336, the UE 300 may be said to be using rank 2. When the UE 300 is receiving the downlink signal using only one receiver (e.g., the first receiver 334), the UE 300 may be said to be using rank 1. In general, the UE 300 may be configured to receive using the same rank as the base station (e.g., base station 120) is using to transmit. The UE 300 may support other ranks and downlink channel configurations in various embodiments.

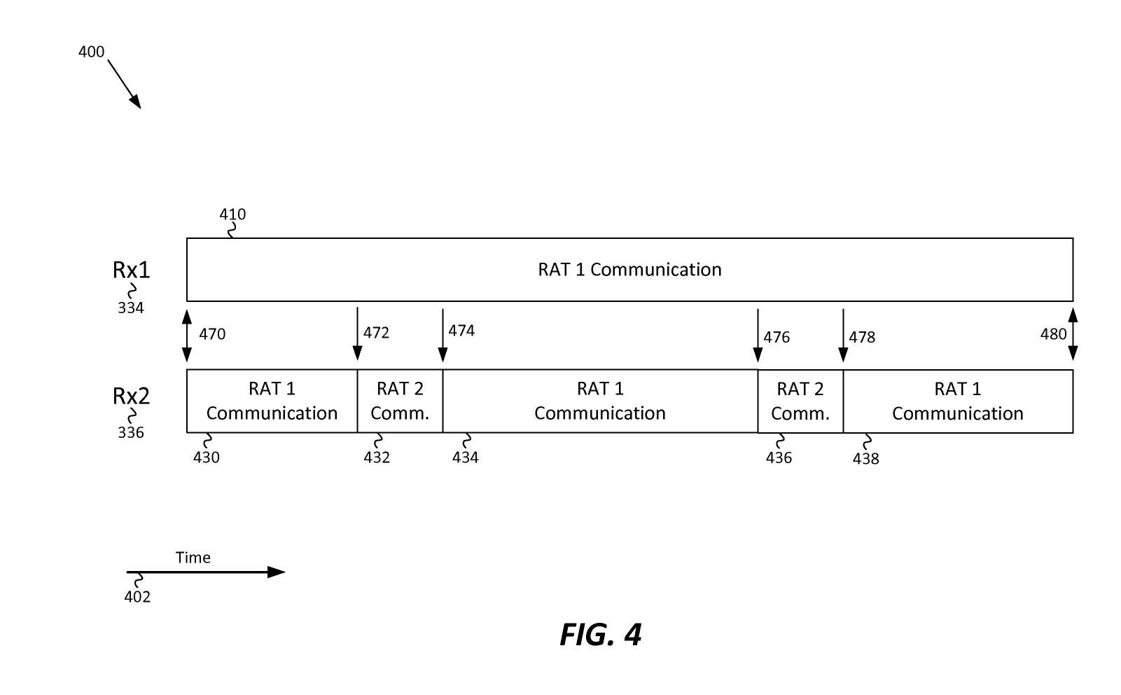

FIG. 4 is a schematic diagram 400 illustrating a communication sequence according to various embodiments. The communication sequence of FIG. 4 may be illustrative of a communication sequence that can be performed using the UE 300 of FIG. 3 (which may be similar to the UEs 110, 200 of FIGS. 1-2). Similar to FIG. 3, the first receiver 334 and the second receiver 336 are shown. With reference to FIGS. 1-4, the communication sequence progresses in time from time 470 to time 480 as indicated by time legend 402.

At the time 470, the first receiver 334 is receiving communications for RAT 1 as indicated by time block 410. Also, the second receiver 336 is receiving communications for RAT 1 as indicated by time block 430. At time 472, communication for RAT 1 is stopped, paused, or otherwise suspended on the second receiver 336. At or after the time 472, the second receiver 336 receives communications for RAT 2 as indicated by time block 432. At time 474, communication for RAT 2 is stopped on the second receiver 336. At or after the time 474, the second receiver 336 starts, unpauses, or otherwise resumes communication for RAT 1 as indicated by time block 434. The reception of communication for RAT 2 as indicated by the time block 432 may include reception of a first communication for RAT 2. The reception of communication for RAT 2 as indicated by the time block 432 may be performed in accordance with a scheduled tune-away operation of the second receiver 336 from RAT 1 to RAT 2. Notably, the reception of communication for RAT 1 on the first receiver 334 continues between the time 472 and the time 474 as indicated by the time block 410.

At or after the time 474 but before time 476, the UE 300 may calculate an error detection result for the communication received for RAT 2 during the time block 432. The error detection result may be the result of an error detection scheme or encoding applied to information bits prior to transmission of the communication received during the time block 432. The error detection result may indicate whether or not one or more bits received during the time block 432 were received in error. The error detection result may indicate whether or not all information bits included in the communication received at the time block 432 could be successfully recovered. In some embodiments, the error detection result may be calculated after a decoding operation was performed for the communication received during the time block 432. In some embodiments, the error detection result may be calculated after an error correction operation was performed for the communication received during the time block 432. In some embodiments, the error detection result may indicate whether or not a block error was detected in the communication received during the time block 432. In some embodiments, the error detection result may be calculated based on application of a cyclic redundancy check (“CRC”) algorithm to a block of data received as part of the communication received during the time block 432. In various embodiments, the error detection result may be otherwise calculated, generated, or determined.

At or after the time 474 but before time 476, the UE may use the error detection result to determine the provision of the first receiver 334 and the second receiver 336 at the time 476. If the error detection result indicates an error in the communication received for RAT 2 during the time block 432, then the UE may determine to provide the first receiver 334 for use for reception of a communication for RAT 2 at the time 476. If the error detection result does not indicate an error in the communication received for RAT 2 during the time block 432, then the UE may determine to provide the second receiver 336 for use for reception of a communication for RAT 2 at the time 476.

In the diagram 400, the error detection result may indicate that no error was detected in the communication received for RAT 2 during the time block 432. As such, the UE may provide the second receiver 336 for reception of communication for RAT 2 at the time 476. Accordingly, at the time 476, communication for RAT 1 is stopped, paused, or otherwise suspended on the second receiver 336. At or after the time 476, the second receiver 336 receives communications for RAT 2 as indicated by time block 436. At time 478, communication for RAT 2 is stopped on the second receiver 336. At or after the time 478, the second receiver 336 starts, unpauses, or otherwise resumes communication for RAT 1 as indicated by time block 438. Notably, the reception of communication for RAT 1 on the first receiver 334 continues between the time 476 and the time 478 as indicated by the time block 410. The diagram 400 ends at the time 480.

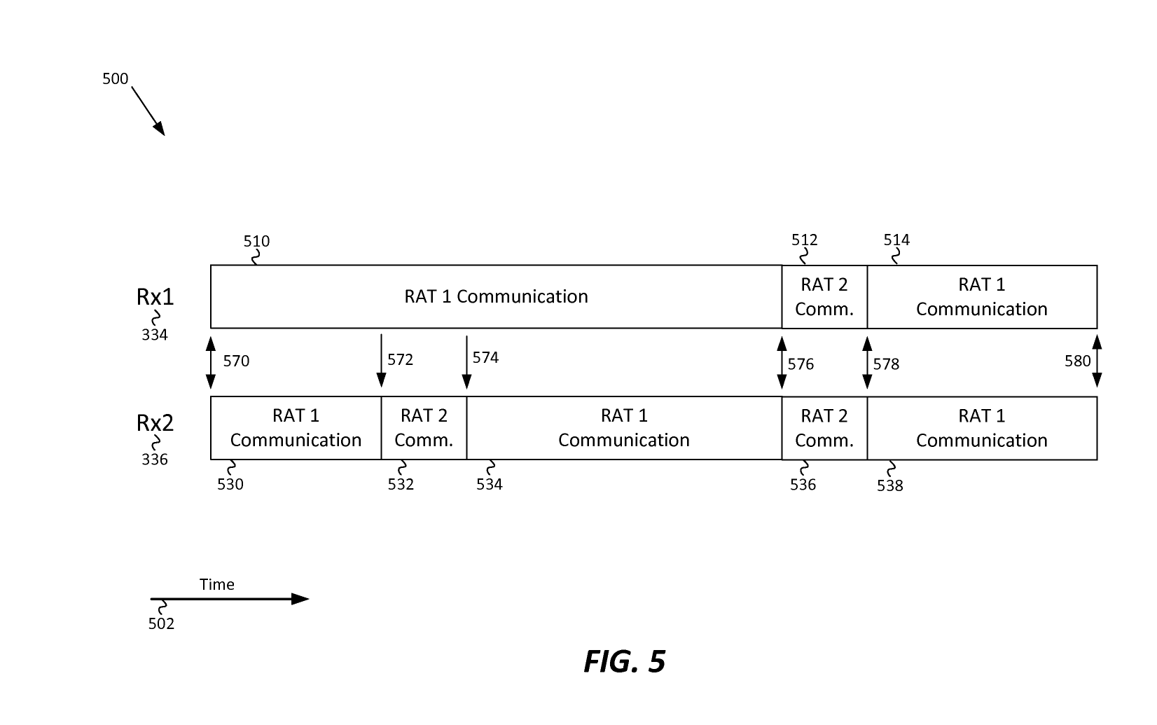

FIG. 5 is a schematic diagram 500 illustrating a communication sequence according to various embodiments. The communication sequence of FIG. 5 may be illustrative of a communication sequence that can be performed using the UE 300 of FIG. 3 (which may be similar to the UEs 110, 200 of FIGS. 1-2). Similar to FIG. 3, the first receiver 334 and the second receiver 336 are shown. With reference to FIGS. 1-5, the communication sequence progresses in time from time 570 to time 580 as indicated by time legend 502.

At time 570, the first receiver 334 is receiving communications for RAT 1 as indicated by time block 510. Also, the second receiver 336 is receiving communications for RAT 1 as indicated by time block 530. At time 572, communication for RAT 1 is stopped, paused, or otherwise suspended on the second receiver 336. At or after the time 572, the second receiver 336 receives communications for RAT 2 as indicated by time block 532. At time 574, communication for RAT 2 is stopped on the second receiver 336. At or after the time 474, the second receiver 336 starts, unpauses, or otherwise resumes communication for RAT 1 as indicated by time block 534. The reception of communication for RAT 2 as indicated by the time block 532 may include reception of a first communication for RAT 2. The reception of communication for RAT 2 as indicated by the time block 532 may be performed in accordance with a scheduled tune-away operation of the second receiver 336 from RAT 1 to RAT 2. Notably, the reception of communication for RAT 1 on the first receiver 334 continues between the time 572 and the time 574 as indicated by the time block 510.

At or after the time 574 but before time 576, the UE 300 may calculate an error detection result for the communication received for RAT 2 during the time block 532. The error detection result may be the result of an error detection scheme or encoding applied to information bits prior to transmission of the communication received during the time block 532. The error detection result may indicate whether or not one or more bits received during the time block 532 were received in error. The error detection result may indicate whether or not all information bits included in the communication received at the time block 532 could be successfully recovered. In some embodiments, the error detection result may be calculated after a decoding operation was performed for the communication received during the time block 532. In some embodiments, the error detection result may be calculated after an error correction operation was performed for the communication received during the time block 532. In some embodiments, the error detection result may indicate whether or not a block error was detected in the communication received during the time block 532. In some embodiments, the error detection result may be calculated based on application of a cyclic redundancy check (“CRC”) algorithm to a block of data received as part of the communication received during the time block 532. In various embodiments, the error detection result may be otherwise calculated, generated, or determined.

At or after the time 574 but before time 576, the UE may use the error detection result to determine the provision of the first receiver 334 and the second receiver 336 at the time 576. If the error detection result indicates an error in the communication received for RAT 2 during the time block 532, then the UE may determine to provide the first receiver 334 for use for reception of a communication for RAT 2 at the time 576. If the error detection result does not indicate an error in the communication received for RAT 2 during the time block 532, then the UE may determine to provide the second receiver 336 for use for reception of a communication for RAT 2 at the time 576.

In the diagram 500, the error detection result may indicate that an error was detected in the communication received for RAT 2 during the time block 532. As such, the UE may provide the first receiver 334 and the second receiver 336 for reception of communication for RAT 2 at the time 576. Accordingly, at the time 576, communication for RAT 1 is stopped, paused, or otherwise suspended on the first receiver 334. In addition, at the time 576, communication for RAT 1 is stopped, paused, or otherwise suspended on the second receiver 336. At or after the time 576, the first receiver 334 receives communications for RAT 2 as indicated by time block 512. At or after the time 576, the second receiver 336 receives communications for RAT 2 as indicated by time block 536. At time 578, communication for RAT 2 is stopped on the first receiver 334 and the second receiver 336. At or after the time 578, the first receiver 334 starts, unpauses, or otherwise resumes communication for RAT 1 as indicated by time block 514. At or after the time 578, the second receiver 336 starts, unpauses, or otherwise resumes communication for RAT 1 as indicated by time block 538. The diagram 500 ends at the time 580.

Though particular examples of communication sequences have been shown in the preceding figures, variations from examples are possible in various embodiments. For example, in the embodiments described with reference to diagram 500, the UE 300 may determine to provide only the first receiver 334 and not the second receiver 336 for reception of communications for RAT 2 between the time 576 and the time 578. As such, between the time 576 and the time 578, the second receiver 336 may continue receiving communications for RAT 1. In such a case, the time block 534 would continue until the time 580, and the time blocks 536 and 538 would be omitted. Other variations are possible in various embodiments.

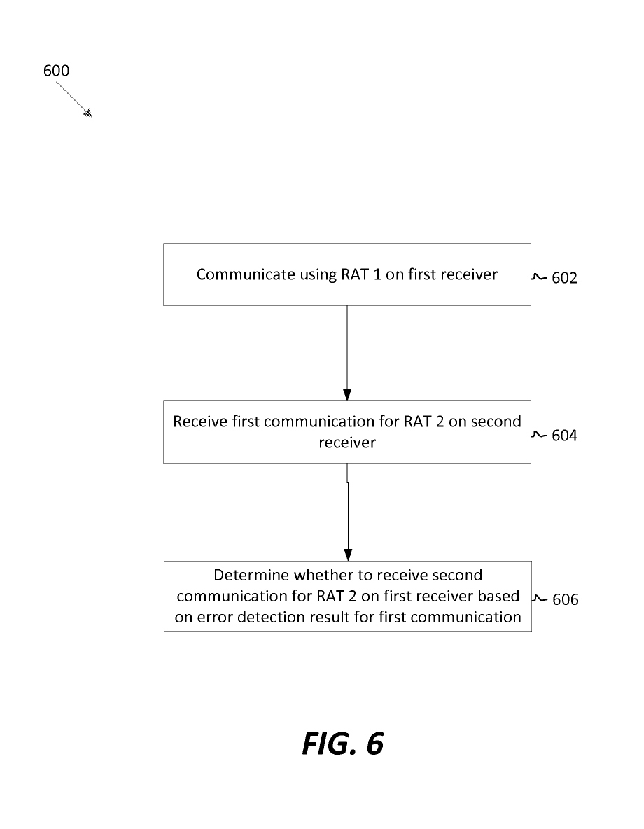

FIG. 6 is a flowchart of a process 600 according to various embodiments. With reference to FIGS. 1-6, the process 600 may be performed by a UE (e.g., the UEs 110, 200, 300). In various embodiments, the operations of the process 600 may be implemented by one or more processors of the UE, such as the processor 201, the baseband processor(s) 205, the system on chip 320, a separate controller (not shown), or the like.

At block 602, communication is performed using RAT 1 on a first receiver. The block 602 may include the first receiver (e.g., the first receiver 334) receiving communications for RAT 1, with RAT 1 being in an active mode, a connected state, or in some other condition requiring constant access to RF resources.

At block 604, a first communication for RAT 2 is received on a second receiver. The block 602 may include the second receiver (e.g., the second receiver 336) receiving communications for RAT 2, with RAT 2 being in an idle mode, a camped state, or in some other condition requiring only intermittent access to RF resources.

At block 606, a determination is made as to whether to receive a second communication for RAT 2 on the first receiver. According to various embodiments, the determination may be made based on an error detection result for the first communication for RAT 2. The block 606 may include a computing component (e.g., the processor 201, the BB processor 205, the system on a chip 320, etc.) determining whether the error detection result indicates an error for the first communication for RAT 2. The block 606 may include the computing component determining to use the first receiver (e.g., the first receiver 334) for reception of the second communication for RAT 2 if the error detection result indicates an error for the first communication for RAT 2. The block 606 may include the computing component determining to not use the first receiver (e.g., the first receiver 334) for reception of the second communication for RAT 2 if the error detection result does not indicate an error for the first communication for RAT 2. The block 606 may include the computing component determining to use the first receiver (e.g., the first receiver 334) and the second receiver (e.g., the second receiver 336) for reception of the second communication for RAT 2 if the error detection result indicates an error for the first communication for RAT 2. The block 606 may include the computing component determining to not use the first receiver (e.g., the first receiver 334) but instead to use the second receiver (e.g., the second receiver 336) for reception of the second communication for RAT 2 if the error detection result does not indicate an error for the first communication for RAT 2.

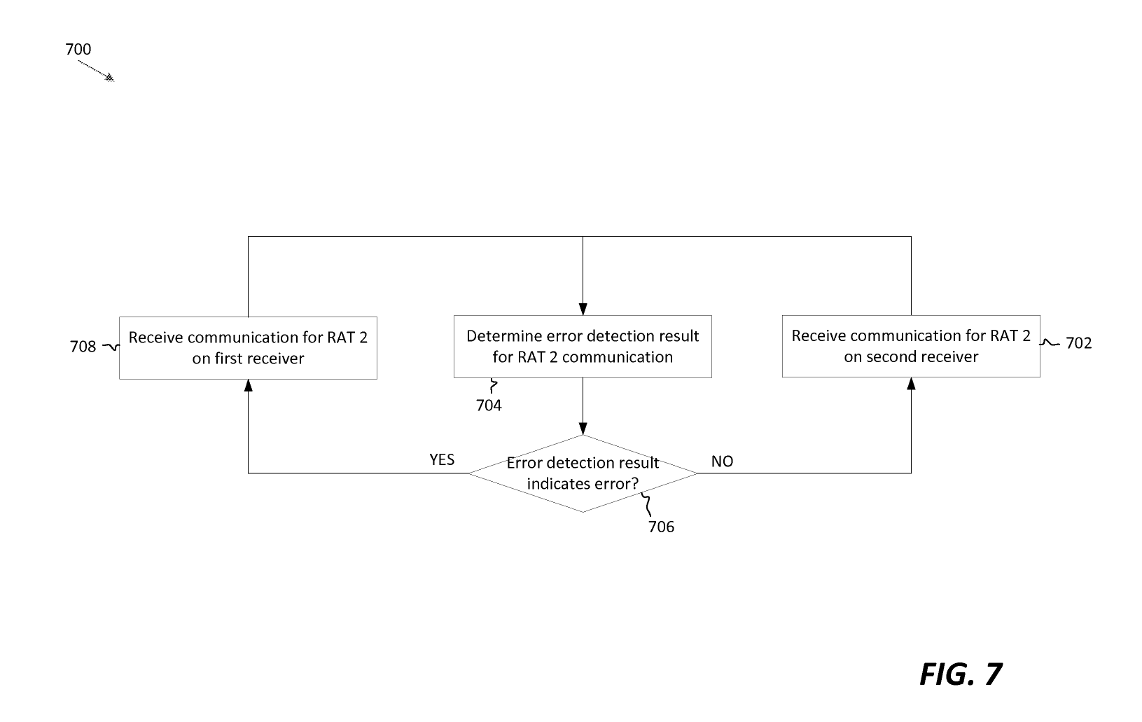

FIG. 7 is a flowchart of a process 700 according to various embodiments. With reference to FIGS. 1-7, the process 700 may be performed by a UE (e.g., the UEs 110, 200, 300). In various embodiments, the operations of the process 700 may be implemented by one or more processors of the UE, such as the processor 201, the baseband processor(s) 205, the system on chip 320, a separate controller (not shown), or the like.

At block 702, communication for RAT 2 is received on a second receiver. The block 702 may include the second receiver (e.g., the second receiver 336) receiving communications for RAT 2, with RAT 2 being in an idle mode, a camped state, or in some other condition requiring only intermittent access to RF resources. In some embodiments, the block 702 may correspond to the block 604 of the process 600.

At block 704, an error detection result is determined for the RAT 2 communication. The block 704 may include a computing component (e.g., the processor 201, the BB processor 205, the system on a chip 320) determining the error detection result based on the most recently received communication for RAT 2 (i.e., the most recent performance of block 702 or block 708). The block 704 may include the computing component applying an error detection algorithm to determine if a block error existed in the communication received for RAT 2.

At block 706, a determination is made as to whether the determined error detection result indicates an error for the RAT 2 communication. The block 706 may include a computing component (e.g., the processor 201, the BB processor 205, the system on a chip 320) determining whether the most recently determined error detection result indicates an error for the most recent communication received for RAT 2. If the error detection result does not indicate an error for the RAT 2 communication (block 706: No), the process 700 continues at the block 702. If the error detection result does indicate an error for the RAT 2 communication (block 706: Yes), the process 700 continues at block 708. In some embodiments, the blocks 704 and 706 may correspond to the block 608 of the process 600.

At the block 708, communication for RAT 2 is received on a first receiver (e.g., the first receiver 334). The block 708 may include the first receiver receiving communications for RAT 2, with RAT 2 being in an idle mode, a camped state, or in some other condition requiring only intermittent access to RF resources.

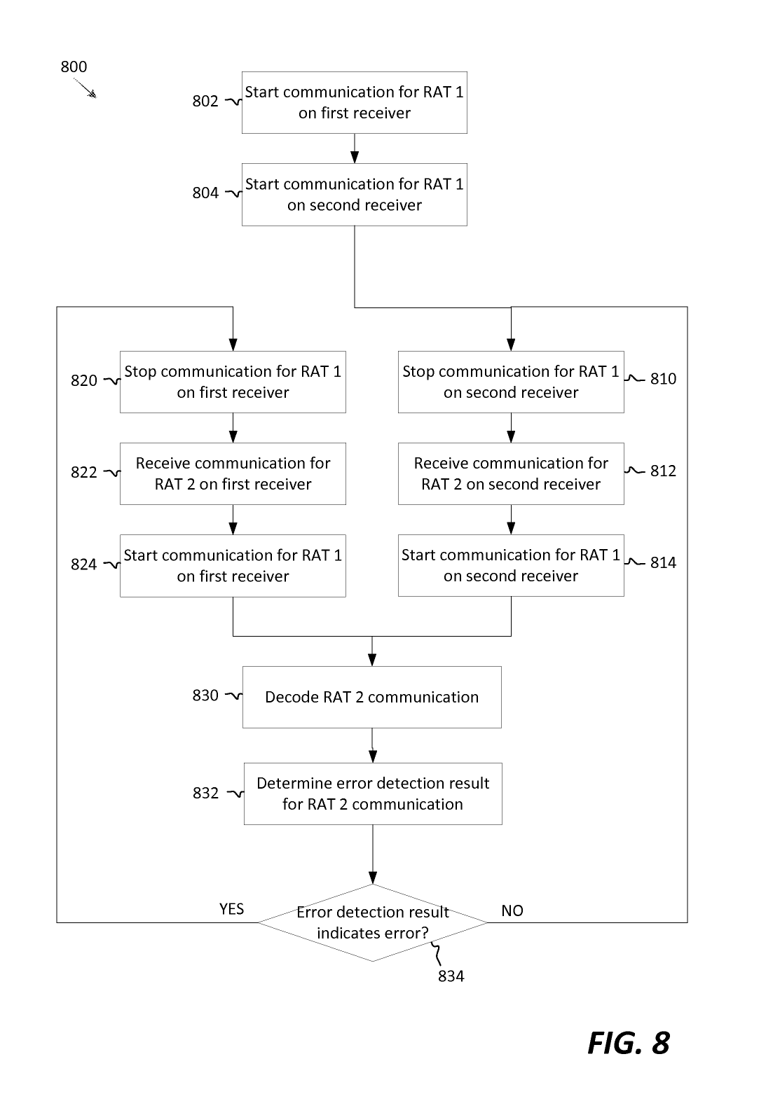

FIG. 8 is a flowchart of a process 800 according to various embodiments. With reference to FIGS. 1-8, the process 800 may be performed by a UE (e.g., the UEs 110, 200, 300). In various embodiments, the operations of the process 800 may be implemented by one or more processors of the UE, such as the processor 201, the baseband processor(s) 205, the system on chip 320, a separate controller (not shown), or the like.

At block 802, communication is started for RAT 1 on a first receiver (e.g., the first receiver 334). The block 802 may include the first receiver starting reception of communications for RAT 1, with RAT 1 being in an active mode, a connected state, or in some other condition requiring constant access to RF resources.

At block 804, communication is started for RAT 1 on a second receiver (e.g., the second receiver 336). The block 804 may include the second receiver starting reception of communications for RAT 1, with RAT 1 being in an active mode, a connected state, or in some other condition requiring constant access to RF resources.

At block 810, communication is stopped for RAT 1 on the second receiver. The block 810 may include stopping communication on the second receiver (e.g., the second receiver 336) in accordance with provisioning of the second receiver for reception of communications for RAT 2. The block 810 may include stopping communication on the second receiver (e.g., the second receiver 336) in accordance with a scheduled tune-away procedure from RAT 1 to RAT 2.

At block 812, communication is received for RAT 2 on the second receiver. The block 812 may include the second receiver (e.g., the second receiver 336) receiving communications for RAT 2, with RAT 2 being in an idle mode, a camped state, or in some other condition requiring only intermittent access to RF resources.

At block 814, communication is started for RAT 1 on the second receiver. The block 814 may include restarting communication on the second receiver (e.g., the second receiver 336) in order to continue the communication initially started with the block 804.

At block 830, the communication received for RAT 2 is decoded. The block 830 may include a computing component (e.g., the processor 201, the BB processor 205, the system on a chip 320) providing the communication received for RAT 2 (i.e., as received at the block 812 or the block 822) to a decoder provided as part of or connected to the computing component. In some embodiments, the block 830 may include the application of an error correction algorithm to the communication received for RAT 2.

At block 832, an error detection result is determined for the communication received for RAT 2. The block 832 may include a computing component (e.g., the processor 201, the BB processor 205, the system on a chip 320) determining the error detection result based on the most recently received communication for RAT 2 (i.e., the most recent performance of the 812 or the block 822). The block 832 may include the computing component determining the error detection result based on the decoded communication for RAT 2 as decoded with the block 830. The block 832 may include the computing component applying an error detection algorithm to determine if a block error existed in the communication received for RAT 2.

At block 834, a determination is made as to whether or not the error detection result indicates an error. The block 834 may include a computing component (e.g., the processor 201, the BB processor 205, the system on a chip 320) determining whether the most recently determined error detection result indicates an error for the most recent communication received for RAT 2. If the error detection result does not indicate an error for the RAT 2 communication (block 834: No), the process 800 continues at the block 810. If the error detection result does indicate an error for the RAT 2 communication (block 834: Yes), the process 800 continues at block 820.

At the block 820, communication is stopped for RAT 1 on the first receiver. The block 820 may include stopping communication on the first receiver (e.g., the first receiver 334) in accordance with provisioning of the first receiver for reception of communications for RAT 2. The block 820 may include stopping communication on the first receiver (e.g., the first receiver 334) in accordance with a scheduled tune-away procedure from RAT 1 to RAT 2.

At block 822, communication is received for RAT 2 on the first receiver. The block 822 may include the first receiver (e.g., the first receiver 334) receiving communications for RAT 2, with RAT 2 being in an idle mode, a camped state, or in some other condition requiring only intermittent access to RF resources.

At block 824, communication is started for RAT 1 on the first receiver. The block 824 may include restarting communication on the first receiver (e.g., the first receiver 334) in order to continue the communication initially started with the block 802.

The process 800 may be modified from that just described in various embodiments. For example, a UE (e.g., the UE 300) implementing the process 800 may wait a period of time after performing the block 834 and before performing the block 810 or the block 820. This period of time may be a predefined interval (e.g., a paging interval for RAT 2). As another example, if the error detection result is determined to indicate an error at the block 834, the process 800 may continue at both the block 810 and the block 820. In such a scenario, both of the first receiver (e.g., the first receiver 334) and the second receiver (e.g., the second receiver 336) may be used to receive the communication for RAT 2 (i.e., both the block 812 and the block 822 may be performed together).

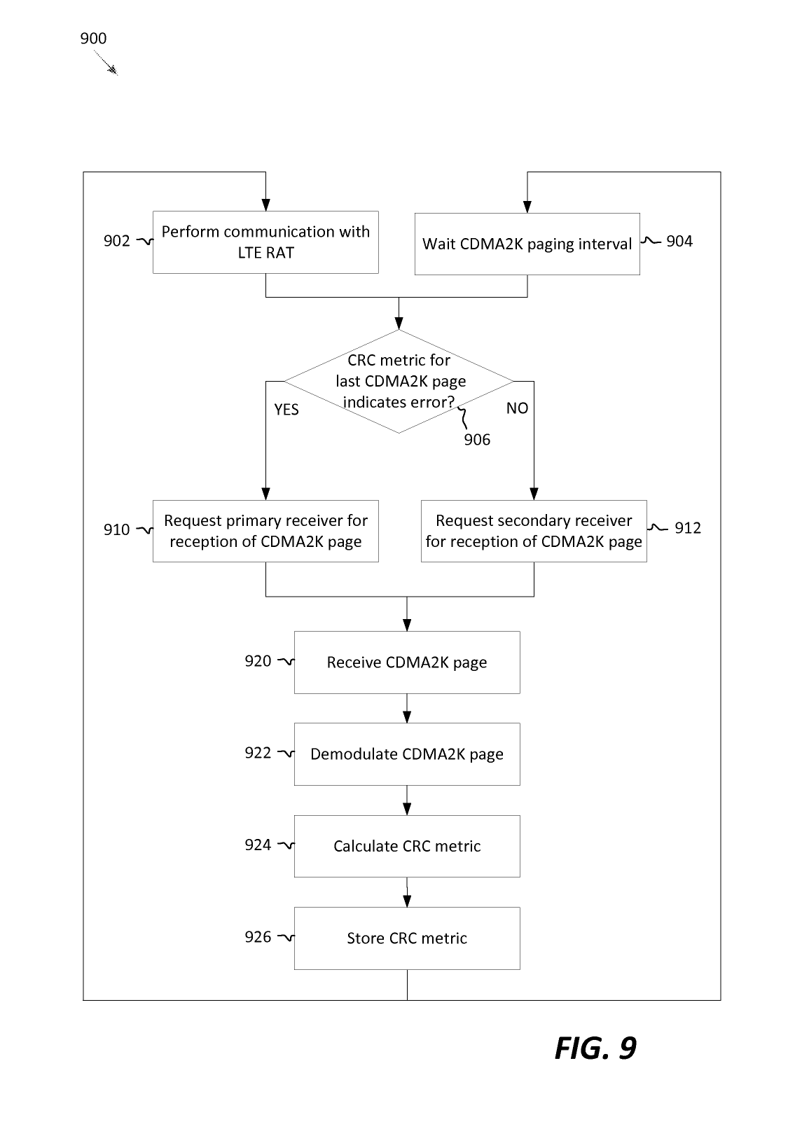

FIG. 9 is a flowchart of a process 900 according to various embodiments. With reference to FIGS. 1-9, the process 900 may be performed by a UE (e.g., the UEs 110, 200, 300). In various embodiments, the operations of the process 900 may be implemented by one or more processors of the UE, such as the processor 201, the baseband processor(s) 205, the system on chip 320, a separate controller (not shown), or the like.

At block 902, communication is performed with an LTE RAT using a primary receiver. The block 902 may include a UE (e.g., the UE 300) communicating while in a connected mode with an LTE RAT. The block 902 may include the UE using a primary receiver (e.g., the first receiver 334) for communication with the LTE RAT. The block 902 may include the UE additionally using a secondary receiver (e.g., the second receiver 336) for communication with the LTE RAT.

At block 904, waiting is performed for a CDMA2000 paging interval. The block 904 may include a computing component (e.g., the processor 201, the BB processor 205, the system on a chip 320) causing the UE (e.g., the UE 300) to wait a period of time for a paging interval for a CDMA2000 RAT with which the UE is in communication. The UE may determine the CDMA2000 paging interval based on a slot cycle index (“SCI”) specified by a computing device (e.g., the base station 110) included in the radio access network for the CDMA2000 RAT. In some embodiments, the block 904 may overlap in time with the performance of the blocks 922, 924, and 926. In some embodiments, the block 904 may include waiting for slightly less time than the CDMA2000 paging interval. The block 904 may be performed at the same time or over a same approximate period as the performance of the block 902.

At block 906, a determination is made as to whether a CRC metric for a last CDMA2000 page indicates an error. The block 906 may include a computing component (e.g., the processor 201, the BB processor 205, the system on a chip 320) retrieving a stored CRC metric (e.g., as stored at the block 926) that indicates whether an error was detected in the most recently received CDMA2000 page. If the CRC metric does indicate an error (block 906: Yes), then the process 900 continues at block 910. If the CRC metric does not indicate an error (block 906: No), then the process 900 continues at block 912.

At the block 910, the primary receiver is requested for reception of a CDMA2000 page. The block 910 may include a computing component (e.g., the processor 201, the BB processor 205, the system on a chip 320) requesting the use of the primary receiver (e.g., the first receiver 334) for use to receive a future CDMA2000 page. The primary receiver may be allocated for reception of the CDMA2000 page in response to the performance of the block 910.

At the block 912, the secondary receiver is requested for reception of a CDMA2000 page. The block 912 may include a computing component (e.g., the processor 201, the BB processor 205, the system on a chip 320) requesting the use of the secondary receiver (e.g., the second receiver 336) for use to receive a future CDMA2000 page. The secondary receiver may be allocated for reception of the CDMA2000 page in response to the performance of the block 912.

At block 920, a CDMA2000 page is received. The block 920 may include using the primary receiver (e.g., the first receiver 334) or the secondary receiver (e.g., the second receiver 336) as requested at the block 910 or the block 912, respectively, to receive a communication from the CDMA2000 RAT including the CDMA2000 page.

At block 922, the CDMA2000 page is demodulated. The block 922 may include a computing component (e.g., the processor 201, the BB processor 205, the system on a chip 320) demodulating the CDMA2000 page received at the block 920.

At block 924, a CRC metric is calculated. The block 924 may include a computing component (e.g., the processor 201, the BB processor 205, the system on a chip 320) determining a CRC result for the CDMA2000 page demodulated at the block 922. The CRC result may indicate whether a block error exists in the demodulated CDMA2000 page. The CRC result may be used as the CRC metric.

At block 926, the CRC metric is stored. The block 926 may include a computing component (e.g., the processor 201, the BB processor 205, the system on a chip 320) storing the CRC metric calculated at the block 924. The CRC metric may be stored in a storage component (e.g., the memory 202, the system on a chip 320). The process 900 may repeat by proceeding to the blocks 902 and 904.

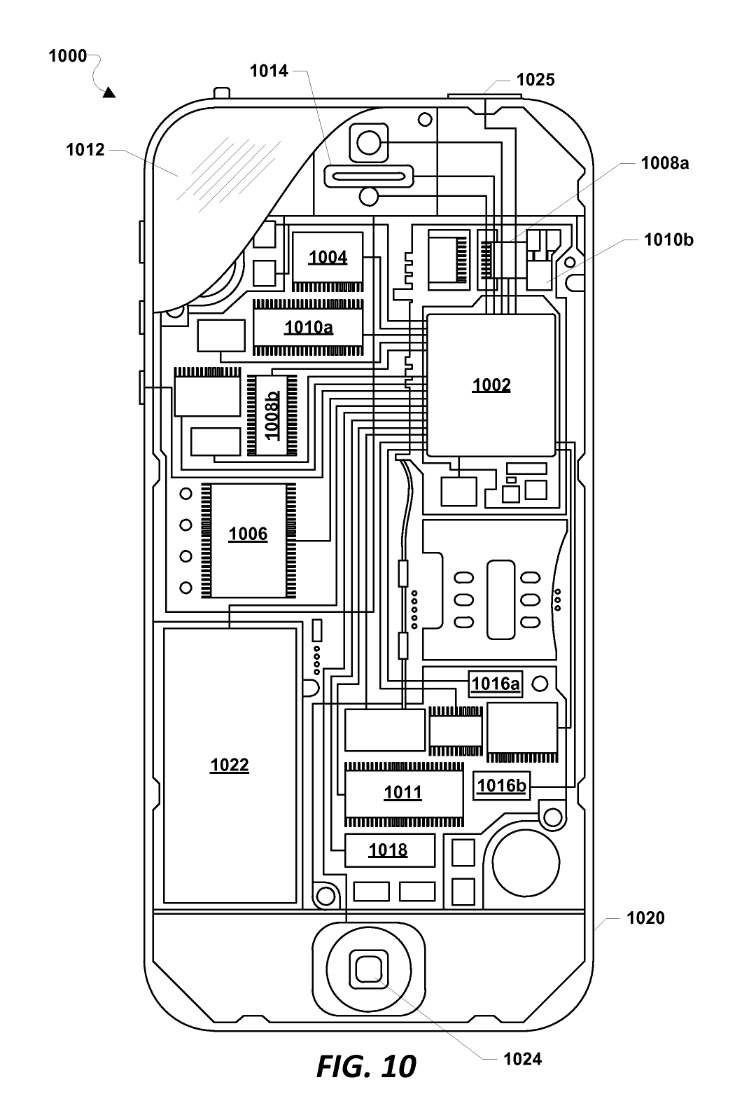

FIG. 10 illustrates an example of a UE 1000, which may correspond to the UEs 110, 200, 300 in FIGS. 1-3. With reference to FIGS. 1-10, the UE 1000 may include a processor 1002 coupled to a touchscreen controller 1004 and an internal memory 1006. The processor 1002 may correspond to the processor 201. The processor 1002 may be one or more multi-core integrated circuits designated for general or specific processing tasks. The internal memory 1006 may correspond to the memory 202. The memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the UE 1000 need not have touch screen capability. The touch screen controller 1004, the touchscreen panel 1012 may correspond to the user interface 203.

The UE 1000 may have one or more cellular network transceivers 1008a, 1008b coupled to the processor 1002 and to two or more antennae 1010 and configured for sending and receiving cellular communications. The transceivers 1008 and antennae 1010a, 1010b may be used with the above-mentioned circuitry to implement the various embodiment methods. The UE 1000 may include two or more SIM cards 1016a, 1016b, corresponding to SIM A 206 and SIM B 207, coupled to the transceivers 1008a, 1008b and/or the processor 1002 and configured as described above. The UE 1000 may include a cellular network wireless modem chip 1011 that enables communication via a cellular network and is coupled to the processor. The one or more cellular network transceivers 1008a, 1008b, the cellular network wireless modem chip 1011, and the two or more antennae 1010 may correspond to the RF resources 204.

The UE 1000 may include a peripheral device connection interface 1018 coupled to the processor 1002. The peripheral device connection interface 1018 may be singularly configured to accept one type of connection, or multiply configured to accept various types of physical and communication connections, common or proprietary, such as USB, FireWire, Thunderbolt, or PCIe. The peripheral device connection interface 1018 may also be coupled to a similarly configured peripheral device connection port (not shown).

The UE 1000 may also include speakers 1014 for providing audio outputs. The UE 1000 may also include a housing 1020, constructed of a plastic, metal, or a combination of materials, for containing all or some of the components discussed herein. The UE 1000 may include a power source 1022 coupled to the processor 1002, such as a disposable or rechargeable battery. The rechargeable battery may also be coupled to a peripheral device connection port (not shown) to receive a charging current from a source external to the UE 1000. The UE 1000 may also include a physical button 1024 for receiving user inputs. The UE 1000 may also include a power button 1026 for turning the UE 1000 on and off.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and flowchart blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Alternatively, some blocks or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to some embodiments without departing from the spirit or scope of the disclosure. Thus, the present disclosure is not intended to be limited to the embodiments shown herein but is to be accorded the widest scope consistent with the following claims and the principles and novel features disclosed herein.

What is claimed is:

1. A method comprising:
communicating using a first radio access technology on a first receiver;
receiving a first communication for a second radio access technology on a second receiver; and
determining whether to receive a second communication for the second radio access technology on the first receiver based on an error detection result for the first communication.

2. The method of claim 1,
wherein determining whether to receive the second communication for the second radio access technology on the first receiver results in a determination to use the first receiver for reception of the second communication for the second radio access technology if the error detection result for the first communication indicates an error for the first communication.

3. The method of claim 2,
wherein determining whether to receive the second communication for the second radio access technology on the first receiver results in a determination to not use the first receiver for reception of the second communication for the second radio access technology if the error detection result for the first communication does not indicate an error for the first communication.

4. The method of claim 1, further comprising:
receiving the second communication for the second radio access technology on the first receiver if the error detection result for the first communication indicates an error for the first communication.

5. The method of claim 4, further comprising:
receiving the second communication for the second radio access technology on the second receiver if the error detection result for the first communication does not indicate an error for the first communication.

6. The method of claim 1,
wherein the first communication comprises one or more bits, and
wherein the error detection result for the first communication indicates whether or not the one or more bits were received in error.

7. The method of claim 1,
wherein the first communication comprises one or more bits, and
wherein the error detection result for the first communication indicates whether or not all information bits included in the first communication could be successfully recovered.

8. The method of claim 1,
wherein the first communication comprises one or more bits, and
wherein the error detection result for the first communication indicates whether or not the one or more bits were detected as being in error after a decoding operation was performed for the first communication.

9. The method of claim 1,
wherein the error detection result for the first communication indicates whether or not one or more bits of the first communication were detected as being in error after an error correction operation was performed for the first communication.

10. The method of claim 1,
wherein the error detection result for the first communication indicates whether or not a block error was detected in the first communication.

11. The method of claim 9,
wherein the error detection result for the first communication is a result of applying a cyclic redundancy check algorithm to a block of data received as part of the first communication.

12. The method of claim 1,
wherein determining whether to receive the second communication for the second radio access technology on the first receiver is not performed based on a signal strength indicator.

13. The method of claim 1,
wherein determining whether to receive the second communication for the second radio access technology on the first receiver is not performed based on a signal strength indicator for the second radio access technology during reception of the first communication for the second radio access technology on the second receiver.

14. The method of claim 1, further comprising:
stopping a communication using the first radio access technology on the first receiver;
receiving the second communication for the second radio access technology on the first receiver, after stopping the communication using the first radio access technology on the first receiver; and
resuming the communication or starting a new communication using the first radio access technology on the first receiver, after receiving the second communication for the second radio access technology on the first receiver.

15. The method of claim 1, further comprising:
stopping a communication using the first radio access technology on the second receiver, before receiving the first communication for the second radio access technology on the second receiver;
receiving the first communication for the second radio access technology on the second receiver, after stopping the communication using the first radio access technology on the second receiver; and
resuming the communication or starting a new communication using the first radio access technology on the second receiver, after receiving the first communication for the second radio access technology on the second receiver,
wherein communicating using a first radio access technology on a first receiver comprises communicating using the first radio access technology on the second receiver, before receiving the first communication for the second radio access technology on the second receiver.

16. The method of claim 15, further comprising:
determining to receive the second communication for the second radio access technology on the first receiver based on the error detection result for the first communication indicating that an error was detected for the first communication;
stopping the communication using the first radio access technology on the first receiver, before receiving the second communication for the second radio access technology on the first receiver;
receiving the second communication for the second radio access technology on the first receiver, after stopping the communication using the first radio access technology on the first receiver; and
resuming the communication or starting a new communication using the first radio access technology on the first receiver, after receiving the second communication for the second radio access technology on the first receiver.

17. The method of claim 16, further comprising:
stopping the communication using the first radio access technology on the second receiver, before receiving the second communication for the second radio access technology on the second receiver;
receiving the second communication for the second radio access technology on the second receiver, after stopping the communication using the first radio access technology on the second receiver; and
resuming the communication or starting a new communication using the first radio access technology on the second receiver, after receiving the second communication for the second radio access technology on the second receiver.

18. The method of claim 15, further comprising:
determining to receive the second communication for the second radio access technology on the second receiver based on the error detection result for the first communication indicating that no error was detected for the first communication;
stopping communication using the first radio access technology on the second receiver, before receiving the second communication for the second radio access technology on the second receiver;
receiving the second communication for the second radio access technology on the second receiver, after stopping communication using the first radio access technology on the second receiver; and
resuming the communication or starting a new communication using the first radio access technology on the second receiver, after receiving the second communication for the second radio access technology on the second receiver.

19. The method of claim 1,
wherein the first communication for the second radio access technology is received on the second receiver based on a tune-away operation on the second receiver from the first radio access technology to the second radio access technology.

20. The method of claim 19,
wherein determining whether to receive a second communication for the second radio access technology on the first receiver comprises determining whether to perform a tune-away operation on the first receiver in order to receive the second communication.

21. The method of claim 1,
wherein the first communication for the second radio access technology is a paging message for the second radio access technology, and
wherein the second communication for the second radio access technology is a paging message for the second radio access technology.

22. The method of claim 21,
wherein the second communication for the second radio access technology is a next paging message for the second radio access technology expected to be received one paging interval in time after the first communication.

23. The method of claim 1,
wherein communicating using the first radio access technology comprises performing active mode communications with a data network radio access technology,
wherein the first communication for the second radio access technology comprises an idle mode communication with a voice network radio access technology, and
wherein the second communication for the second radio access technology comprises an idle mode communication with the voice network radio access technology.

24. The method of claim 1,
wherein the first receiver is a receiver with a greater sensitivity than the second receiver.

25. The method of claim 1,
wherein the second receiver provides spatial diversity reception for signals received at the first receiver.

26. The method of claim 1,
wherein the first radio access technology is different from the second radio access technology.

27. A user equipment (UE) apparatus comprising:
a first receiver configured to communicate using a first radio access technology;
a second receiver configured to receive a first communication for a second radio access technology; and
a processor configured to determine whether to receive a second communication for the second radio access technology on the first receiver based on an error detection result for the first communication.

28. A user equipment (UE) apparatus comprising:
means for communicating using a first radio access technology on a first receiver;
means for receiving a first communication for a second radio access technology on a second receiver; and
means for determining whether to receive a second communication for the second radio access technology on the first receiver based on an error detection result for the first communication.

29. A non-transitory computer-readable medium, the medium comprising instructions configured to cause one or more computing devices to:
communicate using a first radio access technology on a first receiver;
receive a first communication for a second radio access technology on a second receiver; and
determine whether to receive a second communication for the second radio access technology on the first receiver based on an error detection result for the first communication.
